(19) United States
(12) Patent Application Publication
(10) Pub. No.: US 2026/0121259 A1
(43) Pub. Date: Apr. 30, 2026

(54) CONDUCTIVE MODULE

(71) Applicant: Yazaki Corporation, Tokyo (JP)

(72) Inventors: Katsunori SATO, Shizuoka (JP); Tatsuya OGA, Shizuoka (JP); Mariko NAKAGAWA, Shizuoka (JP); Masato TANAKA, Shizuoka (JP)

(73) Assignee: Yazaki Corporation, Tokyo (JP)

(21) Appl. No.: 19/003,368

(22) Filed: Dec. 27, 2024

(30) Foreign Application Priority Data
Jan. 30, 2024 (JP) 2024-012102

(51) Int. Cl. H01M 50/569; H01M 50/517; H01M 50/552

(52) U.S. Cl. CPC H01M 50/569; H01M 50/517; H01M 50/552

(57) ABSTRACT

A conductive module includes: a terminal connection structure that keeps a first electrode terminal and a second electrode terminal in an overlapping state; and a conductive member that is electrically connected to a battery monitoring unit, in which the first electrode terminal and the second electrode terminal include bonding portions that bond the first electrode terminal and the second electrode terminal to each other by pressing bonding surfaces against each other, the terminal connection structure includes a first pressure member that applies a pressure to the bonding portion and a second pressure member that applies a pressure to the bonding portion, and the second pressure member is physically and electrically connected to the conductive member to electrically connect the conductive member to the first electrode terminal and the second electrode terminal.

### CROSS-REFERENCE TO RELATED APPLICATION(S)

The present application claims priority to and incorporates by reference the entire contents of Japanese Patent Application No. 2024-012102 filed in Japan on Jan. 30, 2024.

### BACKGROUND OF THE INVENTION

### 1. Field of the Invention

The present invention relates to a conductive module.

### 2. Description of the Related Art

A conductive module physically and electrically connects electrode terminals of adjacent battery cells to each other in a battery module in which a plurality of battery cells are arranged. For example, Japanese Patent Application Laid-open No. 2014-086360 discloses a terminal connection structure in which flat plate portions of electrode terminals of adjacent battery cells overlap each other, and the flat plate portions are screwed and fixed to each other using male screw members inserted into notches of the flat plate portions.

In the battery module, a battery state of each battery cell is monitored by a battery monitoring unit. The conductive module may also serve to electrically connect the battery cell to the battery monitoring unit. Therefore, in the conductive module according to the related art, there is room for improvement in this respect.

### SUMMARY OF THE INVENTION

Therefore, an object of the present invention is to provide a conductive module having a battery monitoring function in a suitable form.

In order to achieve the above mentioned object, a conductive module according to one aspect of the present invention includes a terminal connection structure that keeps a first electrode terminal of one battery cell and a second electrode terminal of the other battery cell in an overlapping state; and a conductive member that is electrically connected to a battery monitoring unit that monitors battery states of the battery cells, wherein the first electrode terminal and the second electrode terminal include flat-plate-shaped bonding portions that bond the first electrode terminal and the second electrode terminal to each other by pressing bonding surfaces on back sides of pressed surfaces against each other, respectively, the terminal connection structure includes a first pressure member that applies a pressure to the pressed surface of the bonding portion of the first electrode terminal and a second pressure member that applies a pressure to the pressed surface of the bonding portion of the second electrode terminal, and the second pressure member is physically and electrically connected to the conductive member to electrically connect the conductive member to the first electrode terminal and the second electrode terminal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is a partially enlarged view of the conductive module according to the embodiment;

FIG. 3 is a perspective view illustrating a first pressure member according to the embodiment;

FIG. 4 is a perspective view illustrating a second pressure member according to the embodiment;

FIG. 5 is a cross-sectional view for describing the conductive module according to the embodiment;

FIG. 6 is a cross-sectional view for describing removal of an oxide film;

FIG. 7 is an exploded perspective view illustrating a conductive module according to a modified example;

FIG. 8 is a perspective view for describing a second pressure member according to the modified example;

FIG. 9 is a cross-sectional view for describing a form in which the second pressure member and a male screw member are fixed according to the modified example;

FIG. 10 is a perspective view for describing a housing member of the second pressure member according to the modified example;

FIG. 11 is a cross-sectional view for describing a form in which the second pressure member and the male screw member according to the modified example are held by the housing member;

FIG. 12 is an explanatory view for describing another application example of the conductive module according to the modified example; and

FIG. 13 is an explanatory view for describing another application example of the conductive module according to the modified example.

### DETAILED DESCRIPTION OF THE PREFERRED EMBODIMENTS

Hereinafter, an embodiment of a conductive module according to the present invention will be described in detail with reference to the drawings. Note that the present invention is not limited by the embodiment.

### Embodiment

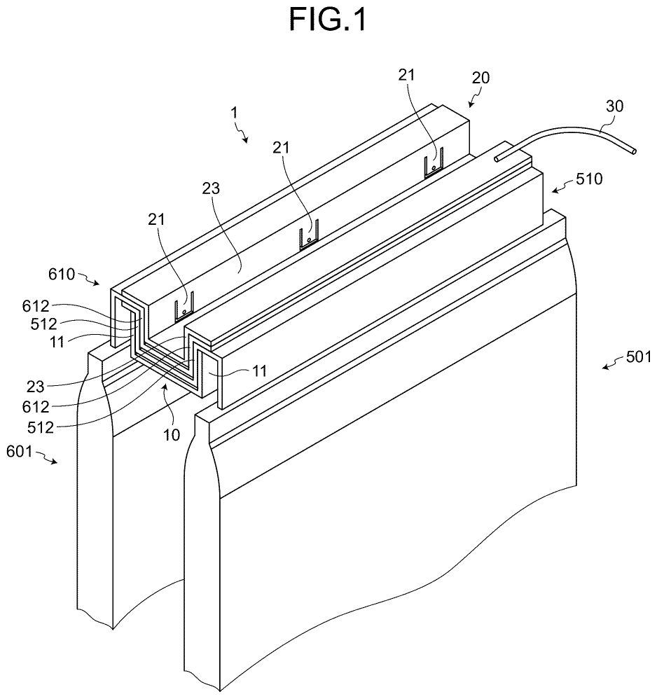

One of embodiments of a conductive module according to the present invention will be described with reference to FIGS. 1 to 6.

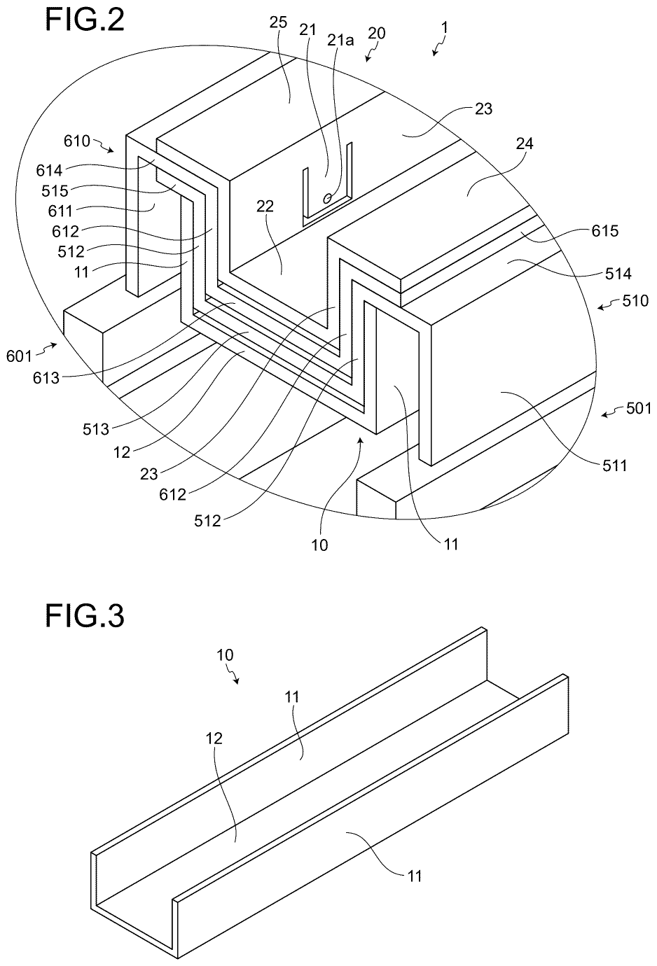

Reference Numeral 1 in FIGS. 1 and 2 denotes a conductive module according to the present embodiment.

The conductive module 1 has a terminal connection structure for physically and electrically connecting electrode terminals of adjacent battery cells to each other. For example, a battery module in which a plurality of battery cells are arranged includes one battery cell (hereinafter, referred to as a “first battery cell”) 501 and the other battery cell (hereinafter, referred to as a “second battery cell”) 601 adjacent to each other (FIGS. 1 and 2). The terminal connection structure physically and electrically connects a first electrode terminal 510 of the first battery cell 501 and a second electrode terminal 610 of the second battery cell 601, thereby keeping the first electrode terminal 510 and the second electrode terminal 610 in an overlapping state. One of the first electrode terminal 510 and the second electrode terminal 610 is a positive electrode, and the other is a negative electrode, for example.

The first electrode terminal 510 and the second electrode terminal 610 include rectangular flat-plate-shaped vertical portions 511 and 611 raised from cell bodies, respectively, and the first electrode terminal 510 and the second electrode terminal 610 overlap each other at portions bent from the vertical portions 511 and 611 toward the second electrode terminal 610 and the first electrode terminal 510 as connection targets (FIG. 2). The first electrode terminal 510 and the second electrode terminal 610 include flat-plate-shaped bonding portions 512 and 612, respectively, the bonding portions 512 and 612 bonding the first electrode terminal 510 and the second electrode terminal 610 to each other by pressing bonding surfaces on back sides of pressed surfaces against each other at the bent portions (FIGS. 1 and 2). In the first electrode terminal 510, a pair of bonding portions 512 is arranged to face each other at an interval in an arrangement direction of the first battery cell 501 and the second battery cell 601. In the second electrode terminal 610, a pair of bonding portions 612 is arranged to face each other at an interval in the arrangement direction.

The terminal connection structure includes a first pressure member 10 that applies a pressure to the pressed surface of the bonding portion 512 of the first electrode terminal 510 and a second pressure member 20 that applies a pressure to the pressed surface of the bonding portion 612 of the second electrode terminal 610 (FIGS. 1 to 5).

The first pressure member 10 is a receiving member including a receiving portion 11 arranged to face the pressed surface of the bonding portion 512 of the first electrode terminal 510 (FIGS. 1 to 3 and 5). The first pressure member 10 illustrated here includes a rectangular first bottom portion 12 and the rectangular receiving portions 11 arranged to face each other at an interval and erected from two side portions of the first bottom portion 12, respectively (FIGS. 2, 3, and 5). Each of the first bottom portion 12 and the receiving portion 11 is formed in a rectangular flat plate shape.

The first pressure member 10 has a groove-shaped first groove portion surrounded by the first bottom portion 12 and the pair of receiving portions 11, and the first electrode terminal 510 is inserted into the first groove portion (FIGS. 2 and 5). The first electrode terminal 510 illustrated here includes a rectangular flat-plate-shaped second bottom portion 513 that is arranged to face the first bottom portion 12 of the first pressure member 10 in the first groove portion of the first pressure member 10 at the portion bent from the vertical portion 511 toward the second electrode terminal 610 as the connection target, and the rectangular flat-plate-shaped bonding portions 512 that are arranged to face each other at an interval, are erected from two side portions of the second bottom portion 513, respectively, and have the pressed surfaces arranged to face the receiving portions 11 of the first pressure member 10 in the first groove portion of the first pressure member 10 (FIGS. 2 and 5).

The first electrode terminal 510 further includes a rectangular flat-plate-shaped coupling portion 514 connecting an end portion of one bonding portion 512 in an erecting direction to the vertical portion 511, and a rectangular flat-plate-shaped protruding piece portion 515 protruding from an end portion of the other bonding portion 512 in the erecting direction in a direction opposite to the one bonding portion 512 (FIGS. 2 and 5). In the first electrode terminal 510, the second bottom portion 513 and the pair of bonding portions 512 are inserted into the first groove portion of the first pressure member 10, and the coupling portion 514 and the protruding piece portion 515 are arranged outside the first groove portion of the first pressure member 10.

The first electrode terminal 510 has a groove-shaped second groove portion surrounded by the second bottom portion 513 and the pair of bonding portions 512 of the first electrode terminal 510, and the second electrode terminal 610 is inserted into the second groove portion (FIGS. 2 and 5). The second electrode terminal 610 illustrated here includes a rectangular flat-plate-shaped third bottom portion 613 that is arranged to face the second bottom portion 513 of the first electrode terminal 510 in the second groove portion of the first electrode terminal 510 at the portion bent from the vertical portion 611 toward the first electrode terminal 510 as the connection target, and the rectangular flat-plate-shaped bonding portions 612 that are arranged to face each other at an interval, are erected from two side portions of the third bottom portion 613, respectively, and have the bonding surfaces arranged to face the bonding surfaces of the bonding portions 512 of the first electrode terminal 510 in the second groove portion of the first electrode terminal 510 (FIGS. 2 and 5).

The second electrode terminal 610 further include a rectangular flat-plate-shaped coupling portion 614 connecting an end portion of one bonding portion 612 in the erecting direction to the vertical portion 611, and a rectangular flat-plate-shaped protruding piece portion 615 protruding from an end portion of the other bonding portion 612 in the erecting direction in a direction opposite to the one bonding portion 612 (FIGS. 2 and 5). In the second electrode terminal 610, the third bottom portion 613 and the pair of bonding portions 612 are inserted into the second groove portion of the first electrode terminal 510, and the coupling portion 614 and the protruding piece portion 615 are arranged outside the second groove portion of the first electrode terminal 510.

The second electrode terminal 610 has a groove-shaped third groove portion surrounded by the third bottom portion 613 and the pair of bonding portions 612 of the second electrode terminal 610, and the second pressure member 20 is inserted into the third groove portion (FIGS. 2 and 5). The second pressure member 20 includes an elastically deformable portion 21 that applies a reaction force accompanying elastic deformation to the pressed surface of the bonding portion 612 of the second electrode terminal 610 to press the bonding surface of the bonding portion 612 of the second electrode terminal 610 against the bonding surface of the bonding portion 512 of the first electrode terminal 510 (FIGS. 1, 2, 4, and 5). In the second pressure member 20, the elastically deformable portion 21 is arranged in the third groove portion of the second electrode terminal 610. The second pressure member 20 illustrated here includes a rectangular flat-plate-shaped fourth bottom portion 22 that is arranged to face the third bottom portion 613 of the second electrode terminal 610 in the third groove portion of the second electrode terminal 610, and rectangular flat-plate-shaped side wall portions 23 that are arranged to face each other at an interval, are erected from two side portions of the fourth bottom portion 22, respectively, and are arranged to face the pressed surfaces of the bonding portions 612 of the second electrode terminal 610 in the third groove portion of the second electrode terminal 610 (FIGS. 2, 4, and 5). The side wall portion 23 has the elastically deformable portion 21 (FIGS. 1, 2, 4, and 5). Each of the pair of side wall portions 23 illustrated here has a plurality of elastically deformable portions 21.

The elastically deformable portion 21 illustrated here is formed in a rectangular flat plate shape having a cantilever shape, and includes a contact point portion 21a having, for example, a hemispherical shape and bulging toward the pressed surface of the bonding portion 612 of the second electrode terminal 610 (FIGS. 2, 4, and 5). The elastically deformable portion 21 applies the reaction force accompanying the elastic deformation to the pressed surface of the bonding portion 612 of the second electrode terminal 610 at the contact point portion 21a. When the elastically deformable portion 21 applies the reaction force accompanying the elastic deformation to the pressed surface of the bonding portion 612 of the second electrode terminal 610, the receiving portion 11 of the first pressure member 10 comes into contact with the pressed surface of the bonding portion 512 of the first electrode terminal 510 and receives the reaction force. As a result, the bonding portion 512 of the first electrode terminal 510 and the bonding portion 612 of the second electrode terminal 610 are sandwiched between the receiving portion 11 of the first pressure member 10 and the elastically deformable portion 21 of the second pressure member 20 in a state where the bonding surfaces of the bonding portion 512 of the first electrode terminal 510 and the bonding portion 612 of the second electrode terminal 610 are pressed against each other, and are physically and electrically connected to each other.

The second pressure member 20 further includes a rectangular flat-plate-shaped first protruding piece portion 24 protruding from an end portion of one side wall portion 23 in the erecting direction in a direction opposite to the other side wall portion 23, and a rectangular flat-plate-shaped second protruding piece 25 protruding from an end portion of the other side wall portion 23 in the erecting direction in a direction opposite to the one side wall portion 23 (FIGS. 2, 4, and 5). In the second pressure member 20, the fourth bottom portion 22 and the pair of side wall portions 23 are inserted into the third groove portion of the second electrode terminal 610, and the first protruding piece portion 24 and the second protruding piece portion 25 are arranged outside the third groove portion of the second electrode terminal 610.

Here, the first electrode terminal 510 and the second electrode terminal 610 are formed of, for example, copper, a copper alloy, aluminum, or an aluminum alloy. The first pressure member 10 and the second pressure member 20 (at least the second pressure member 20) are formed of stainless steel. Therefore, an oxide film is formed on the surfaces of the first electrode terminal 510, the second electrode terminal 610, the first pressure member 10, and the second pressure member 20.

However, in the conductive module 1, when the second pressure member 20 is inserted into the third groove portion of the second electrode terminal 610, the contact point portion 21a of the elastically deformable portion 21 of the second pressure member 20 slides on the pressed surface of the bonding portion 612 of the second electrode terminal 610, as a result of which the oxide film on the pressed surface and the contact point portion 21a is broken.

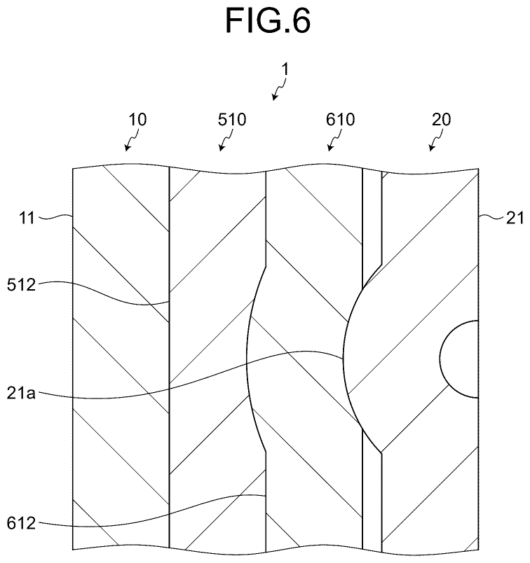

In addition, in the conductive module 1, when the insertion of the second pressure member 20 is finished, the contact point portion 21a of the elastically deformable portion 21 deforms the bonding portion 612 of the second electrode terminal 610 along a shape of the contact point portion 21a of the elastically deformable portion 21 by a pressing force, as a result of which a portion of the bonding surface of the bonding portion 612 bulges (FIG. 6). In the conductive module 1, the bulging portion of the bonding surface of the bonding portion 612 applies a pressing force to the bonding surface of the bonding portion 512 of the first electrode terminal 510, and the pressing force deforms the bonding portion 512 of the first electrode terminal 510 along a shape of the bulging portion of the bonding portion 612 (FIG. 6). Therefore, in the first electrode terminal 510 and the second electrode terminal 610, the oxide film is broken at deformed portions of the bonding portions 512 and 612. Therefore, in the conductive module 1, it is possible to achieve a favorable conduction state between the contact point portion 21a of the elastically deformable portion 21 of the second pressure member 20 and the pressed surface of the bonding portion 612 of the second electrode terminal 610 and between the bonding portion 512 of the first electrode terminal 510 and the bonding portion 612 of the second electrode terminal 610.

Furthermore, in the conductive module 1, not only the elastically deformable portion 21 of the second pressure member 20 but also the entire second pressure member 20 may be elastically deformed by having a spring property. As a result, in the conductive module 1, for example, the protruding piece portion 615 of the second electrode terminal 610 and the coupling portion 514 of the first electrode terminal 510 may be sandwiched between the first protruding piece portion 24 and the one receiving portion 11 of the first pressure member 10 by elastically deforming the one side wall portion 23 and the first protruding piece portion 24 with respect to the fourth bottom portion 22 and applying the pressing force to the protruding piece portion 615 of the second electrode terminal 610 from the first protruding piece portion 24. Further, in the conductive module 1, for example, the coupling portion 614 of the second electrode terminal 610 and the protruding piece portion 515 of the first electrode terminal 510 may be sandwiched between the second protruding piece portion 25 and the other receiving portion 11 of the first pressure member 10 by elastically deforming the other side wall portion 23 and the second protruding piece portion 25 with respect to the fourth bottom portion 22 and applying the pressing force to the coupling portion 614 of the second electrode terminal 610 from the second protruding piece portion 25.

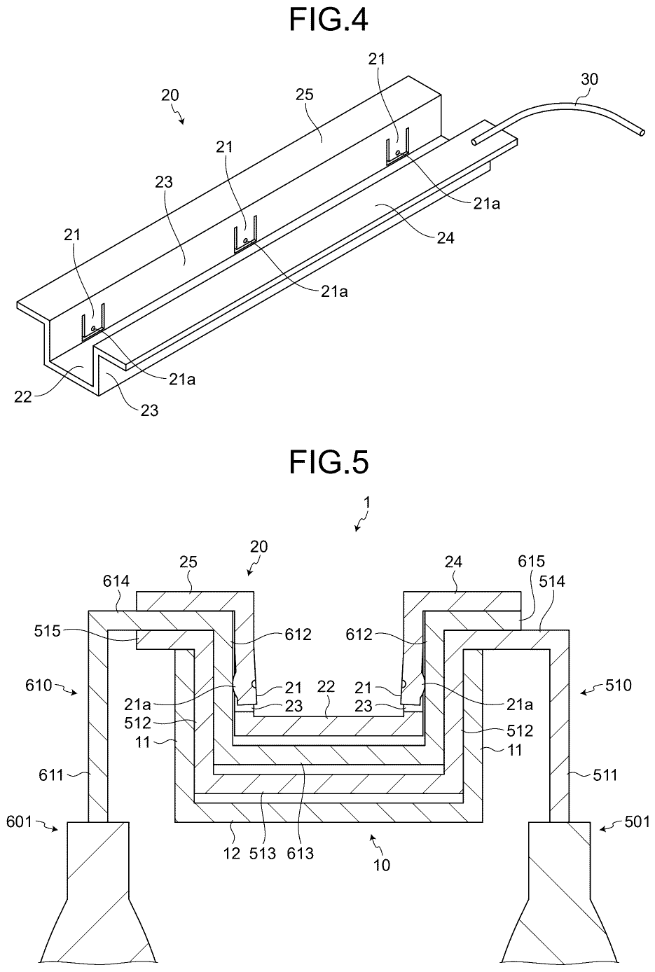

The conductive module 1 includes a conductive member 30 electrically connected to a battery monitoring unit that monitors a battery state of the battery cell (FIGS. 1 and 4). The conductive member 30 is a voltage detection line which is one of members included in a voltage detection circuit, and causes the battery monitoring unit to monitor a voltage state of the battery cell. For example, an electric wire, a conductor pattern of a flexible printed circuit (FPC) board, or the like is used as the conductive member 30. In a case where the conductive module 1 includes a flexible printed circuit board, a temperature sensor (for example, a chip-shaped temperature sensor) that detects a temperature of the battery cell, a circuit protection member (for example, a chip-shaped circuit protection member) such as a fuse, or the like may be mounted on the flexible printed circuit board.

In the conductive module 1, the second pressure member 20 also serves as a voltage detection terminal which is one of the members included in the voltage detection circuit. The second pressure member 20 is physically and electrically connected to the conductive member 30. As a result, the second pressure member 20 can electrically connect the conductive member 30 to the first electrode terminal 510 and the second electrode terminal 610. For example, the conductive member 30 is physically and electrically connected to the second pressure member 20 by welding or the like before the second pressure member 20 is assembled to the second electrode terminal 610. In the conductive module 1, the first pressure member 10 may also serve as the voltage detection terminal.

As described above, the conductive module 1 according to the present embodiment has the terminal connection structure in which the first electrode terminal 510 and the second electrode terminal 610 are sandwiched using at least the spring property of the elastically deformable portion 21 of the second pressure member 20, and the electrical connection between the first electrode terminal 510 and the second electrode terminal 610 can be established with a simple structure in which the first electrode terminal 510 and the second electrode terminal 610 are simply sandwiched by the first pressure member 10 and the second pressure member 20. In other words, in the conductive module 1 according to the present embodiment, the first pressure member 10 and the second pressure member 20 can be easily removed, and workability in attaching and detaching the first electrode terminal 510 and the second electrode terminal 610 can be improved. Further, in the conductive module 1 according to the present embodiment, since a part (the second pressure member 20) of the terminal connection structure can be used as the voltage detection terminal, not only the electrical connection between the first electrode terminal 510 and the second electrode terminal 610 can be established, but also the first electrode terminal 510 and the second electrode terminal 610 can be electrically connected to the conductive member 30 and the battery monitoring unit only by work of sandwiching the first electrode terminal 510 and the second electrode terminal 610 by the first pressure member 10 and the second pressure member 20. Therefore, the conductive module 1 according to the present embodiment can efficiently perform connection work of physically and electrically connecting the first electrode terminal 510 and the second electrode terminal 610 to each other and connection work of electrically connecting the first electrode terminal 510 and the second electrode terminal 610 to the battery monitoring unit. In the conductive module 1 according to the present embodiment, a part (the second pressure member 20) of the terminal connection structure also serves as the voltage detection terminal, so that the number of components can be reduced. Therefore, the conductive module 1 according to the present embodiment can have a battery monitoring function in a suitable form.

### Modified Example

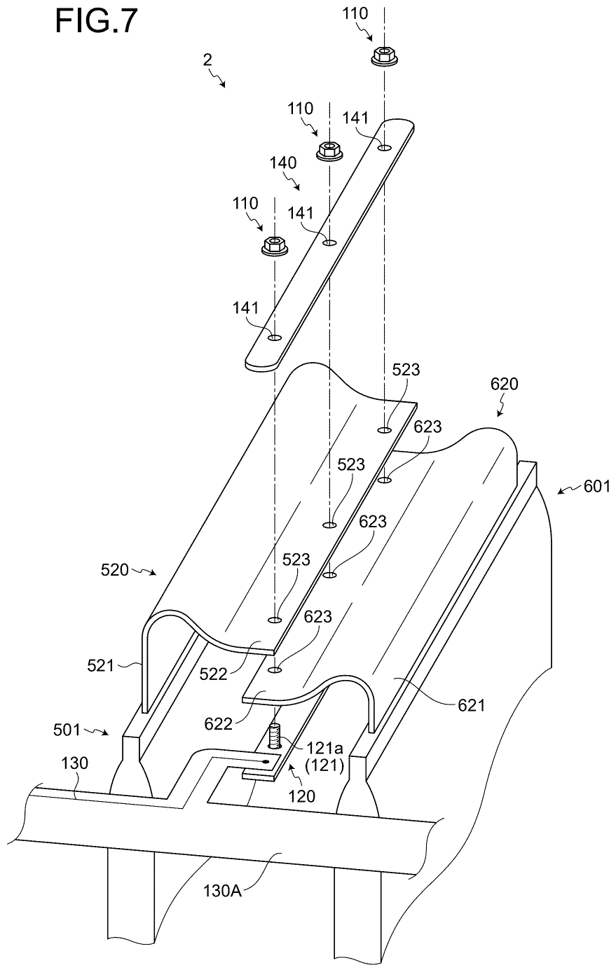

Reference Numeral 2 in FIG. 7 denotes a conductive module according to the present modified example. Similarly to the conductive module 1 according to the embodiment described above, the conductive module 2 has a terminal connection structure for physically and electrically connecting electrode terminals of adjacent battery cells to each other. In the present modified example, the first electrode terminal 510 of the first battery cell 501 is replaced with a first electrode terminal 520, and the second electrode terminal 610 of the second battery cell 601 is replaced with a second electrode terminal 620 (FIG. 7). One of the first electrode terminal 520 and the second electrode terminal 620 is a positive electrode, and the other is a negative electrode, for example.

Similarly to the first electrode terminal 510 and the second electrode terminal 610 according to the embodiment, the first electrode terminal 520 and the second electrode terminal 620 according to the present modified example include rectangular flat-plate-shaped vertical portions 521 and 621 raised from cell bodies, respectively, and the first electrode terminal 520 and the second electrode terminal 620 include rectangular flat-plate-shaped bonding portions 522 and 622, respectively, at portions bent from the vertical portions 521 and 621 toward the second electrode terminal 620 and the first electrode terminal 520 as connection targets (FIG. 7). However, the first electrode terminal 520 and the second electrode terminal 620 according to the present modified example each form an L shape outside the cell body, and end portions of the portions bent from the vertical portions 521 and 621 toward the connection targets are the bonding portions 522 and 622. In the bonding portions 522 and 622, bonding surfaces on back sides of pressed surfaces are arranged to face each other in a direction orthogonal to an arrangement direction of a first battery cell 501 and a second battery cell 601, and the bonding portions 522 and 622 are bonded to each other by pressing the bonding surfaces against each other.

Similarly to the terminal connection structure according to the embodiment, the terminal connection structure according to the present modified example includes a first pressure member 110 that applies a pressure to the pressed surface of the bonding portion 522 of the first electrode terminal 520 and a second pressure member 120 that applies a pressure to the pressed surface of the bonding portion 622 of the second electrode terminal 620 (FIG. 7). However, the second pressure member 120 according to the present modified example is formed in a flat plate shape and includes a male screw portion or a female screw portion. The first pressure member 110 according to the present modified example is a female screw member to be screwed to the male screw portion or a male screw member to be screwed to the female screw portion. In the terminal connection structure illustrated here, the female screw member is used for the first pressure member 110, and a male screw portion 121a is provided in the second pressure member 120 (FIG. 7).

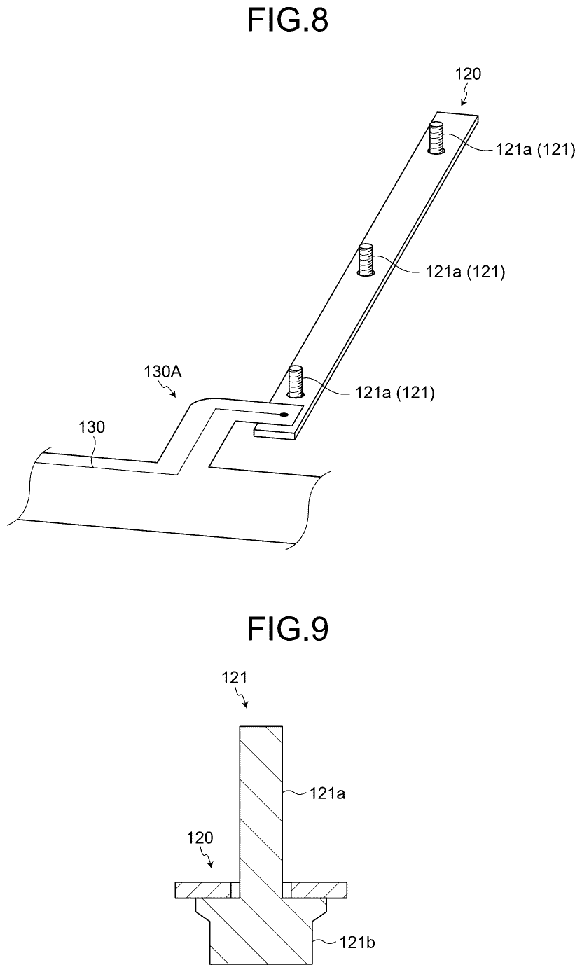

The second pressure member 120 illustrated here is formed in a rectangular flat plate shape. Then, a male screw member 121 is fixed to the second pressure member 120 illustrated here by welding, caulking, or the like in a state where the male screw portion 121a vertically extends on one plane (FIGS. 8 and 9). That is, the second pressure member 120 illustrated here is formed as one component integrated with the male screw portion 121a.

One or a plurality of male screw portions 121a are provided in the second pressure member 120. Here, a plurality of male screw members 121 are fixed to the second pressure member 120, and the first pressure member 110 paired with each of the male screw members 121 is prepared (FIGS. 7 and 8). In a case where a female screw portion is provided in the second pressure member 120 and a male screw member is used for the first pressure member 110, the female screw portion may be processed in the second pressure member 120, or a female screw member may be fixed to the second pressure member 120 by welding, caulking, or the like.

Male screw insertion portions 523 and 623 through which the male screw portion 121a of the male screw member 121 is inserted is formed in the bonding portions 522 and 622 (FIG. 7). The male screw insertion portions 523 and 623 are formed as through-holes or U-shaped notches. However, such a notch may cause a bias in a stress generated when the screwing of the first pressure member 110 and the male screw portion 121a of the second pressure member 120 is completed, and may lower stability of the electrical connection. Therefore, it is desirable to provide the male screw insertion portions 523 and 623 having through-hole shapes in the bonding portions 522 and 622.

In the terminal connection structure according to the present modified example, the bonding portion 622 of the second electrode terminal 620 is placed on the second pressure member 120 while inserting the male screw portion 121a into the male screw insertion portion 623, and then the bonding portion 522 of the first electrode terminal 520 is placed on the bonding portion 622 of the second electrode terminal 620 while inserting the male screw portion 121a into the male screw insertion portion 523 (FIG. 7). In the terminal connection structure according to the present modified example, the first pressure member 110 as the female screw member is screwed to each of the male screw portions 121a (FIG. 7). Thus, the conductive module 2 according to the present modified example physically and electrically connects the bonding portion 522 of the first electrode terminal 520 and the bonding portion 622 of the second electrode terminal 620 to each other.

Further, similarly to the conductive module 1 according to the embodiment, the conductive module 2 according to the present modified example includes a conductive member 130 electrically connected to a battery monitoring unit (FIG. 7). Similarly to the conductive member 30 according to the embodiment, an electric wire, a conductor pattern of a flexible printed circuit (FPC) board, or the like is used as the conductive member 130. In a case where the conductive module 2 includes a flexible printed circuit board, a temperature sensor (for example, a chip-shaped temperature sensor), a circuit protection member (for example, a chip-shaped circuit protection member), or the like may be mounted on the flexible printed circuit board similarly to the conductive module 1 according to the embodiment. In this example, a flexible printed circuit board 130A is provided (FIG. 7).

Similarly to the conductive module 1 according to the embodiment, in the conductive module 2 according to the present modified example, the second pressure member 120 also serves as a voltage detection terminal. The second pressure member 120 is physically and electrically connected to the conductive member 130 by welding or the like to electrically connect the conductive member 130 to the first electrode terminal 520 and the second electrode terminal 620. In the conductive module 2, the first pressure member 110 may also serve as the voltage detection terminal.

As described above, the conductive module 2 according to the present modified example uses a screw fixing mechanism for fastening and fixing the first electrode terminal 520 and the second electrode terminal 620 together in the terminal connection structure, and the electrical connection between the first electrode terminal 520 and the second electrode terminal 620 can be established with a simple structure in which the first electrode terminal 520 and the second electrode terminal 620 are simply sandwiched by the first pressure member 110 and the second pressure member 120 included in the screw fixing mechanism. In other words, in the conductive module 2 according to the present modified example, the first pressure member 110 and the second pressure member 120 can be easily removed, and workability in attaching and detaching the first electrode terminal 520 and the second electrode terminal 620 can be improved. Further, in the conductive module 2 according to the present modified example, since a part (the second pressure member 120) of the terminal connection structure can be used as the voltage detection terminal, not only the electrical connection between the first electrode terminal 520 and the second electrode terminal 620 can be established, but also the first electrode terminal 520 and the second electrode terminal 620 can be electrically connected to the conductive member 130 and the battery monitoring unit only by work of sandwiching the first electrode terminal 520 and the second electrode terminal 620 by the first pressure member 110 and the second pressure member 120. Therefore, the conductive module 2 according to the present modified example can efficiently perform connection work of physically and electrically connecting the first electrode terminal 520 and the second electrode terminal 620 to each other and connection work of electrically connecting the first electrode terminal 520 and the second electrode terminal 620 to the battery monitoring unit. In the conductive module 2 according to the present modified example, a part (the second pressure member 120) of the terminal connection structure also serves as the voltage detection terminal, so that the number of components can be reduced. Therefore, the conductive module 2 according to the present modified example can have a battery monitoring function in a suitable form.

Here, the conductive module 2 according to the present modified example may include a flat-plate-shaped conductive washer member 140 that functions as a washer between the pressed surface of the bonding portion 522 of the first electrode terminal 520 and a plurality of first pressure members 110 (female screw members or male screw members) (FIG. 7). The washer member 140 is formed in a rectangular flat plate shape using a metal material or the like, and a through-hole 141 is formed for each first pressure member 110. Furthermore, in this case, in order to cause the second pressure member 120 to also function as a washer, the second pressure member 120 is formed of a metal material or the like to impart conductivity to the second pressure member 120.

In this case, in the conductive module 2 according to the present modified example, the first electrode terminal 520 and the second electrode terminal 620 are sandwiched between the flat-plate-shaped second pressure member 120 and the flat-plate-shaped washer member 140, and a cross-sectional area of an electrical connection portion therebetween can be increased. Therefore, in the conductive module 2 according to the present modified example, an electric resistance can be reduced by the washer member 140.

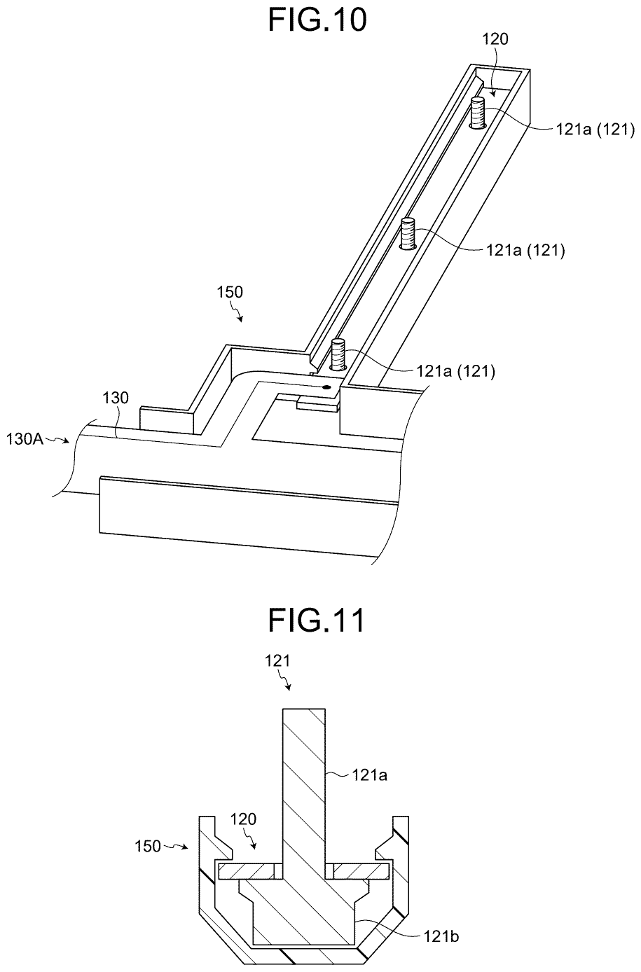

In addition, the conductive module 2 according to the present modified example may include an insulating housing member 150 that houses the flat-plate-shaped second pressure member 120 and holds a head portion 121b of the male screw member 121 (or the female screw member) (FIGS. 10 and 11).

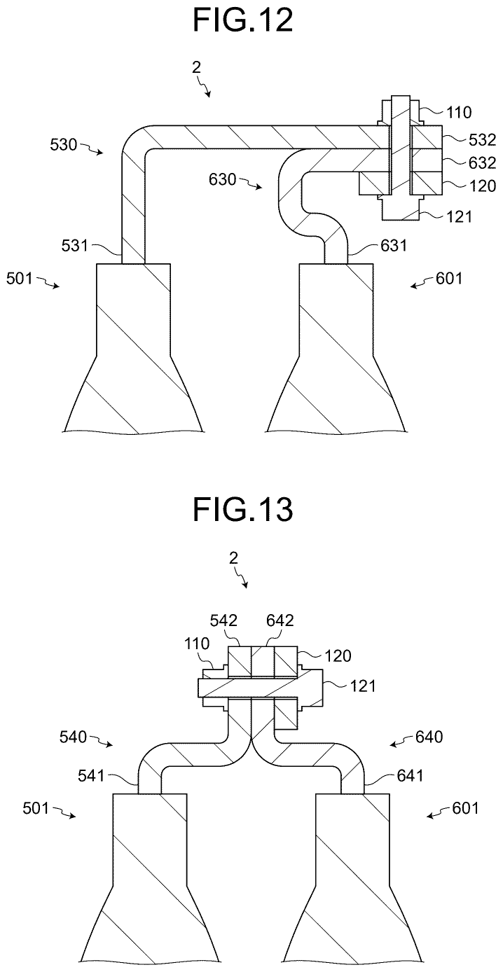

Although the conductive module 2 according to the present modified example is described to be applied to the first electrode terminal 520 and the second electrode terminal 620 bent from the vertical portions 521 and 621 on cell body sides toward the connection targets, the present invention is not limited thereto. For example, the conductive module 2 according to the present modified example may be applied to a first electrode terminal 530 and a second electrode terminal 630 in which portions are bent in the same direction in the arrangement direction of the battery cells from vertical portions 531 and 631 on cell body sides and which have end portions of the bent portions as flat-plate-shaped bonding portions 532 and 632, respectively (FIG. 12). Alternatively, the conductive module 2 according to the present modified example may be applied to a first electrode terminal 540 and a second electrode terminal 640 in which portions are bent from first vertical portions 541 and 641 on cell body sides toward connection targets and which have, as flat-plate-like bonding portions 542 and 642, second vertical portions further vertically extending in the same direction as the first vertical portions 541 and 641 at the bent portions, respectively (FIG. 13).

The conductive module according to the present embodiment can establish electrical connection between the first electrode terminal and the second electrode terminal with a simple structure in which the first electrode terminal and the second electrode terminal are simply sandwiched by the first pressure member and the second pressure member. In other words, in the conductive module according to the present embodiment, the first pressure member and the second pressure member can be easily removed, and workability in attaching and detaching the first electrode terminal and the second electrode terminal can be improved. Further, in the conductive module according to the present embodiment, since a part (the second pressure member) of the terminal connection structure can be used as the voltage detection terminal, not only the electrical connection between the first electrode terminal and the second electrode terminal can be established, but also the first electrode terminal and the second electrode terminal can be electrically connected to the conductive member and the battery monitoring unit only by work of sandwiching the first electrode terminal and the second electrode terminal by the first pressure member and the second pressure member. Therefore, the conductive module according to the present embodiment can efficiently perform connection work of physically and electrically connecting the first electrode terminal and the second electrode terminal to each other and connection work of electrically connecting the first electrode terminal and the second electrode terminal to the battery monitoring unit. In the conductive module according to the present embodiment, a part (the second pressure member) of the terminal connection structure also serves as the voltage detection terminal, so that the number of components can be reduced. Therefore, the conductive module according to the present embodiment can have a battery monitoring function in a suitable form.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a terminal connection structure that keeps a first electrode terminal of one battery cell and a second electrode terminal of the other battery cell in an overlapping state; and
a conductive member that is electrically connected to a battery monitoring unit that monitors battery states of the battery cells, wherein
the first electrode terminal and the second electrode terminal include flat-plate-shaped bonding portions that bond the first electrode terminal and the second electrode terminal to each other by pressing bonding surfaces on back sides of pressed surfaces against each other, respectively,
the terminal connection structure includes a first pressure member that applies a pressure to the pressed surface of the bonding portion of the first electrode terminal and a second pressure member that applies a pressure to the pressed surface of the bonding portion of the second electrode terminal, and
the second pressure member is physically and electrically connected to the conductive member to electrically connect the conductive member to the first electrode terminal and the second electrode terminal.

2. The conductive module according to claim 1, wherein
the first pressure member is a receiving member including a receiving portion arranged to face the pressed surface of the bonding portion of the first electrode terminal,
the second pressure member includes an elastically deformable portion that applies a reaction force accompanying elastic deformation to the pressed surface of the bonding portion of the second electrode terminal to press the bonding surface of the bonding portion of the second electrode terminal against the bonding surface of the bonding portion of the first electrode terminal, and
when the elastically deformable portion applies the reaction force accompanying the elastic deformation to the pressed surface of the bonding portion of the second electrode terminal, the receiving portion comes into contact with the pressed surface of the bonding portion of the first electrode terminal and receives the reaction force.

3. The conductive module according to claim 2, wherein
the first pressure member includes a rectangular first bottom portion and the rectangular receiving portions arranged to face each other at an interval and erected from two side portions of the first bottom portion, and has a groove-shaped first groove portion which is surrounded by the first bottom portion and a pair of the receiving portions and into which the first electrode terminal is inserted,
the first electrode terminal includes a rectangular flat-plate-shaped second bottom portion arranged to face the first bottom portion of the first pressure member in the first groove portion, and the rectangular flat-plate-shaped bonding portions arranged to face each other at an interval, erected from two side portions of the second bottom portion, and arranged such that the pressed surfaces of the bonding portions face the receiving portions in the first groove portion, and has a groove-shaped second groove portion which is surrounded by the second bottom portion and a pair of the bonding portions of the first electrode terminal) and into which the second electrode terminal is inserted,
the second electrode terminal includes a rectangular flat-plate-shaped third bottom portion arranged to face the second bottom portion of the first electrode terminal in the second groove portion, and the rectangular flat-plate-shaped bonding portions arranged to face each other at an interval, erected from two side portions of the third bottom portion, and arranged such that the bonding surfaces of the bonding portions face the bonding surfaces of the bonding portions of the first electrode terminal in the second groove portion, and has a groove-shaped third groove portion which is surrounded by the third bottom portion and a pair of the bonding portions of the second electrode terminal and into which the second pressure member is inserted,
the second pressure member includes a rectangular flat-plate-shaped fourth bottom portion arranged to face the third bottom portion of the second electrode terminal in the third groove portion, and rectangular flat-plate-shaped side wall portions arranged to face each other at an interval, erected from two side portions of the fourth bottom portion, and arranged to face the pressed surfaces of the bonding portions of the second electrode terminal in the third groove portion, and
the side wall portion includes the elastically deformable portion.

4. The conductive module according to claim 1, wherein
the second pressure member is formed in a flat plate shape and includes a male screw portion or a female screw portion, and
the first pressure member is a female screw member to be screwed to the male screw portion or a male screw member to be screwed to the female screw portion.
